(19) United States
(12) Patent Application Publication
(10) Pub. No.: US 2024/0336280 A1
(43) Pub. Date: Oct. 10, 2024

(54) CONTROL APPARATUS

(71) Applicants: DENSO CORPORATION, Kariya-city (JP); J-QuAD DYNAMICS Inc., Tokyo (JP)

(72) Inventors: Akira ITO, Tokyo (JP); Kazuya Hanamoto, Tokyo (JP); Shigenori Ichinose, Tokyo (JP)

(73) Assignees: DENSO CORPORATION, Kariya-city (JP); J-QuAD DYNAMINCS INC., Tokyo (JP)

(21) Appl. No.: 18/750,202

(22) Filed: Jun. 21, 2024

Related U.S. Application Data
(63) Continuation of application No. PCT/JP2022/037959, filed on Oct. 12, 2022.

(30) Foreign Application Priority Data
Dec. 22, 2021 (JP) 2021-208190

(51) Int. Cl. B60W 60/00; B60W 30/18

(52) U.S. Cl. CPC B60W 60/001; B60W 30/18009; B60W 2530/10; B60W 2552/30; B60W 2720/10

(57) ABSTRACT

A control apparatus for a moving body generates a trajectory plan that is a plan indicating a lateral position of the moving body at each point when the moving body is caused to travel along a predetermined route. The control apparatus generates a speed plan that is a plan indicating a traveling speed of the moving body at each point when the moving body is caused to travel along the route. The control apparatus causes the moving body to travel based on both the trajectory plan and the speed plan. The control apparatus generates the speed plan as a plan for causing the moving body to travel based on the trajectory plan after the the trajectory plan is generated.

### CROSS-REFERENCE TO RELATED APPLICATION

The present application is a continuation application of International Application No. PCT/JP2022/037959, filed on Oct. 12, 2022, which claims priority to Japanese Patent Application No. 2021-208190, filed on Dec. 22, 2021. The contents of these applications are incorporated herein by reference in their entirety.

### BACKGROUND

### Technical Field

The present disclosure relates to a control apparatus for a moving body.

### Related Art

Technologies for automating some or all driving operations of a vehicle are being developed. Such technologies include what are referred to as advanced driver assistance systems (ADAS) and autonomous driving (AD). For example, a technique is known in which a suitable target speed based on a preferred speed of an occupant is set, and driving force of an engine and the like are automatically adjusted so that an actual speed becomes the target speed.

### SUMMARY

An aspect of the present disclosure provides a control apparatus for a moving body. This control apparatus generates a trajectory plan that is a plan indicating a lateral position of the moving body at each point when the moving body is caused to travel along a predetermined route. The control apparatus generates a speed plan that is a plan indicating a traveling speed of the moving body at each point when the moving body is caused to travel along the route. The control apparatus causes the moving body to travel based on both the trajectory plan and the speed plan. The control apparatus generates the speed plan as a plan for causing the moving body to travel based on the trajectory plan after the trajectory plan is generated.

### BRIEF DESCRIPTION OF THE DRAWINGS

In the accompanying drawings:

FIG. 1 is a block diagram schematically illustrating a configuration of a control apparatus according to a present embodiment;

FIG. 2 is a flowchart illustrating processes performed by the control apparatus; and

FIG. 3 is a diagram for explaining an example of a trajectory plan.

### DESCRIPTION OF THE EMBODIMENTS

Technologies for automating some or all driving operations of a vehicle are being developed. Such technologies include what are referred to as advanced driver assistance systems (ADAS) and autonomous driving (AD). For example, JP 4513247 B2 describes a technique in which a suitable target speed based on a preferred speed of an occupant is set, and driving force of an engine and the like are automatically adjusted so that an actual speed becomes the target speed.

Technological advancement in this field has been remarkable and competition in development is intensifying not only domestically, but also globally. In addition, infrastructure has become more developed in recent years. Acquiring information required for control from advanced road transportation systems and using detailed map data including topographic information have become possible. Furthermore, as a result of advancement in individual technological development of actuator control, electric brakes, and the like, fine control related to movement of a vehicle has become possible.

As the information that can be used for control becomes more detailed and diverse, and the degree of freedom in control improves with advancement in hardware technology, it is thought that even more advanced control will become possible in the future. For example, implementation of control that further improves traveling performance, riding comfort, energy efficiency, and the like of a vehicle is expected.

The inventors of the present invention are examining reduction of energy required for vehicle travel through optimization of automatic adjustment of a trajectory on which a vehicle travels, in addition to optimization of automatic adjustment of a traveling speed of the vehicle. Here, “trajectory” as used herein refers to a trajectory that indicates, when a vehicle travels on a certain track, a section of the track in a width direction in which the vehicle travels. Therefore, “automatic adjustment of the trajectory” means automatic adjustment of a “lateral position” of the vehicle during traveling.

As a method for enabling such control, generating both a speed plan that indicates a manner in which the traveling speed of the vehicle is to be changed during a predetermined period in the future and a trajectory plan that indicates the trajectory along which the vehicle is to be made to travel during the predetermined period, and causing the vehicle to travel based on both the speed plan and the trajectory plan can be considered. If both the speed plan and the trajectory plan are generated to be optimized so that the consumed energy is minimized, energy efficiency of the vehicle can be improved.

For example, to generate the above-described speed plan, the speed plan is required to be formulated as an optimization problem and solved, taking into consideration not only the dynamics of the vehicle but also a plurality of factors such as powertrain efficiency characteristics of an engine, a motor, and the like, and external information such as gradient and curvature of the track. However, as the information that can be used for control increases, computational load for actualizing the control using the information also naturally increases. Therefore, even in a case in which only the speed plan is generated, an enormous amount of computational resources is required and actualization may be difficult in a control apparatus that can be mounted in a vehicle. In cases in which the trajectory plan is also to be optimized in addition to the speed plan, the required computational resources naturally further increase.

It is thus desired to provide a control apparatus that is capable of reducing computational load required for generating a trajectory plan and a speed plan.

A first exemplary embodiment of the present disclosure provides a control apparatus for a moving body and includes: a first plan generation unit that generates a trajectory plan that is a plan indicating a lateral position of the moving body at each point when the moving body is caused to travel along a predetermined route; a second plan generation unit that generates a speed plan that is a plan indicating a traveling speed of the moving body at each point when the moving body is caused to travel along the route; and a traveling control unit that causes the moving body to travel based on both the trajectory plan and the speed plan. The second plan generation unit generates the speed plan as a plan for causing the moving body to travel based on the trajectory plan after the first plan generation unit generates the trajectory plan.

The control apparatus configured as such first generates the trajectory plan and subsequently generates the speed plan as a plan to cause the moving body to travel based on the trajectory plan. That is, rather than both the trajectory plan and the speed plan being simultaneously generated by a complex optimization problem being solved, only the trajectory plan is first generated independently of the speed plan. As a result, computational load required to generate the trajectory plan can be reduced. In addition, the speed plan is generated on the premise of traveling based on the existing trajectory plan. Consequently, computational load required to generate the speed plan can also be reduced.

Here, an effect of improvement in energy efficiency is small compared to the case in which both the trajectory plan and the speed plan are simultaneously generated by complex computation. However, because the required computational load can be significantly reduced, great advantages can be achieved such, as the overall control apparatus being able to be configured as an onboard electronic control unit (ECU).

As a result of the exemplary embodiment of the present disclosure, a control apparatus that is capable of reducing computational load required to generate a trajectory plan and a speed plan is provided.

A second exemplary embodiment of the present disclosure provides a non-transitory computer-readable storage medium having stored thereon a program for a control apparatus of a moving body, the program causing the control apparatus to perform: a first plan generating process of generating a trajectory plan that is a plan indicating a lateral position of the moving body at each point when the moving body is caused to travel along a predetermined route; a second plan generating process of generating speed plan that is a plan indicating a traveling speed of the moving body at each point when the moving body is caused to travel along the route; and a traveling control process of causing the moving body to travel based on both the trajectory plan and the speed plan. The second plan generating process includes a process of generating the speed plan as a plan for causing the moving body to travel based on the trajectory plan after the trajectory plan is generated as the first plan generating process.

A third exemplary embodiment of the present disclosure provides a control apparatus for a moving body, the control apparatus including: a processor; a non-transitory computer-readable storage medium; a set of computer-executable instructions stored on the computer-readable storage medium that, when read and executed by the processor, cause the processor to implement: generating a trajectory plan that is a plan indicating a lateral position of the moving body at each point when the moving body is caused to travel along a predetermined route; generating a speed plan that is a plan indicating a traveling speed of the moving body at each point when the moving body is caused to travel along the route; and causing the moving body to travel based on both the trajectory plan and the speed plan. Generating the speed plan includes generating the speed plan as a plan for causing the moving body to travel based on the trajectory plan after the the trajectory plan is generated.

A present embodiment will hereinafter be described with reference to the accompanying drawings. To facilitate understanding of the descriptions, identical constituent elements in the drawings are given the same reference numbers whenever possible. Redundant descriptions are omitted.

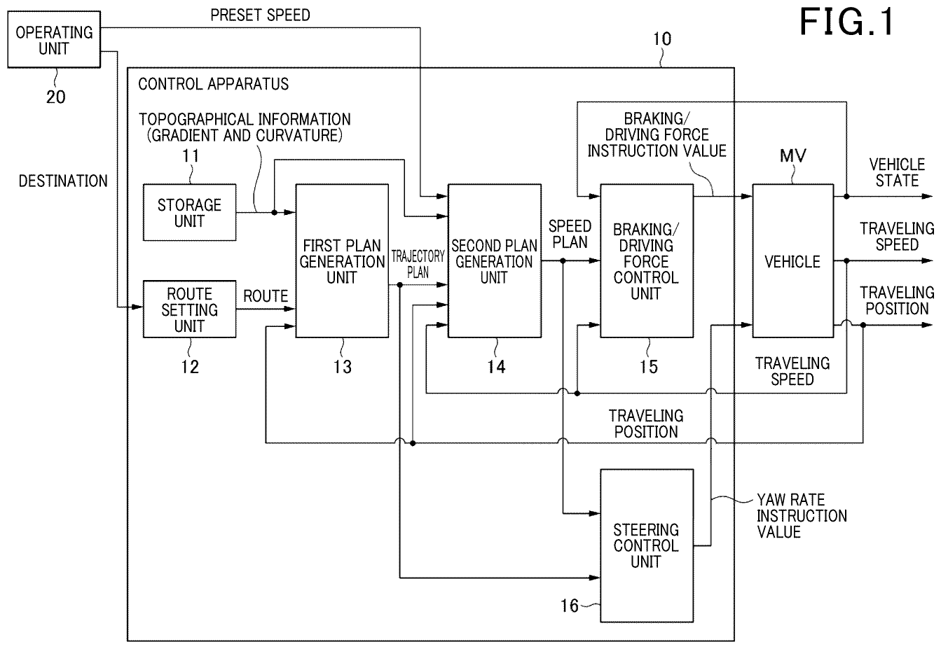

A control apparatus 10 according to the present embodiment is configured as an apparatus for controlling operations of a vehicle MV. FIG. 1 shows the vehicle MV to be controlled as a schematic block. The vehicle MV is, for example, an electric vehicle and includes a rotating electric machine (not shown) as an apparatus that generates driving force required for traveling. Instead of an aspect such as that above, the vehicle MV may be a vehicle that travels by driving force from an internal combustion engine. In addition, the vehicle MV may be a hybrid vehicle that is capable of traveling by respective driving forces of the internal combustion engine and the rotating electric machine.

The vehicle MV according to the present embodiment is configured as a so-called “autonomous driving vehicle” that automatically performs all driving operations. Instead of an aspect such as this, the vehicle MV may be a vehicle that automatically performs only a part of a drive operation (accelerator operation), braking operation (brake operation), and steering (steering wheel operation). In either case, automatic driving operations are actualized by control performed by the control apparatus 10. In addition, an aspect in which the control apparatus 10 causes an occupant to perform appropriate driving operations by instructing, to the occupant, a target speed, a target trajectory, and the like rather than automatically performing operations on behalf of the occupant is also possible.

The control apparatus 10 is configured as a computer system that has a central processing unit (CPU), a read-only memory (ROM), a random access memory (RAM), and the like. The overall control apparatus 10 is mounted in the vehicle MV to be controlled. In other words, the control apparatus 10 is configured as a so-called onboard electronic control unit (ECU). The control apparatus 10 according to the present embodiment is configured as a single apparatus. However, the control apparatus 10 may be configured as a plurality of apparatuses that communicate bidirectionally with each other. In addition, an aspect in which some or all functions of the control apparatus 10 described hereafter are actualized by a server disposed in a position differing from the vehicle MV is also possible.

FIG. 1 schematically shows a configuration of the control apparatus 10 as a block diagram. As block elements representing the functions of the control apparatus 10, the control apparatus 10 includes a storage unit 11, a route setting unit 12, a first plan generation unit 13, a second plan generation unit 14, a braking/driving force control unit 15, and a steering control unit 16.

The storage unit 11 is a non-volatile storage apparatus provided in the control apparatus 10. For example, the storage unit 11 is a solid-state drive (SSD) or a hard disk drive (HDD). The storage unit 11 stores various types of information required for processes performed by the control apparatus 10. The information includes topography at each point of a track on which the vehicle MV may travel, specifically, gradient, curvature, number of lanes, width of each lane, and the like at each point. The information stored in the storage unit 11 may be updated each time based on passage of time, a traveling position of the vehicle MV, or the like.

The route setting unit 12 is a section that performs a process to set a route to be travelled for the vehicle MV to reach a destination. In a vehicle cabin (not shown) of the vehicle MV, an operating unit 20 that is a section operated by the occupant is provided as, for example, a touch panel. When the occupant operates the operating unit 20 and sets a desired destination, the route setting unit 12 sets an appropriate route from a current location to the destination. The route setting unit 12 preferably sets the route so that energy required for traveling is minimized. For example, a route that is as flat as possible or a route that has the shortest distance is preferably set. Here, the route setting unit 12 and the operating unit 20 may be part of a navigation system mounted in the vehicle MV.

The first plan generation unit 13 is a section that performs a process to generate a trajectory plan. The “trajectory plan” refers to a plan that indicates a lateral position of the vehicle MV at each point when the vehicle MV is caused to travel along the route set by the route setting unit 12. The trajectory plan is generated as the lateral position at each point every time the vehicle MV travels a predetermined distance along the route. As the “lateral position,” for example, a distance from a center position of a track along a left/right direction to a center position of a vehicle along the same direction is used.

The first plan generation unit 13 generates the trajectory plan based on the route set by the route setting unit 12, the topographic information such as curvature stored in the storage unit 11, and the traveling position of the vehicle MV. The traveling position of the vehicle MV can be acquired based on, for example, a signal from a global positioning satellite (GPS) sensor mounted in the vehicle MV. The first plan generation unit 13 generates the trajectory plan so that the energy required for traveling is reduced. A specific method for generating the trajectory plan will be described hereafter.

The second plan generation unit 14 is a section that performs a process to generate a speed plan. The “speed plan” refers to a plan that indicates a traveling speed of the vehicle MV at each point when the vehicle MV is caused to travel along the route set by the route setting unit 12. The speed plan is generated as the traveling speed at each time every time a predetermined amount of time elapses. In a manner similar to the trajectory plan described above, the speed plan may be generated as the traveling speed at each point every time the vehicle MV travels a predetermined distance along the route.

The occupant of the vehicle MV can input a desired preset speed by operating the operating unit 20. The second plan generation unit 14 generates the speed plan so that the vehicle MV travels at or near the preset speed.

In addition to the above-described preset speed, the second plan generation unit 14 generates the speed plan based on the topographic information such as the gradient and curvature stored in the storage unit 11, the trajectory plan generated by the first plan generation unit 13, a current traveling position and traveling speed of the vehicle MV, and the like. The current traveling position of the vehicle MV can be acquired based on, for example, a signal from a speed sensor mounted in the vehicle MV. The second plan generation unit 14 generates the speed plan so that the vehicle MV travels at a speed near the preset speed and the energy required for traveling is reduced. A specific method for generating the speed plan will be described hereafter.

The braking/driving force control unit 15 is a section that performs a process to cause the vehicle MV to travel based on the speed plan. The braking/driving force control unit 15 adjusts braking force and driving force of the vehicle MV (hereafter also collectively referred to as “braking/driving force”) so that the traveling speed of the vehicle MV at each time subsequent to the current time matches the traveling speed indicated in the speed plan. Specifically, the braking/driving force control unit 15 causes the vehicle MV to travel while adjusting the braking/driving force by performing feedback control so that a deviation between the traveling speed indicated in the speed plan and the actual traveling speed is reduced.

The braking/driving force control unit 15 performs the above-described feedback control based on the speed plan, the current traveling speed, and a current vehicle state. The “vehicle stat” refers to various parameters used as state variables in control, such as rotation speed and torque of the rotating electric machine included in the vehicle MV, and a gravitational center position of the vehicle MV. The braking/driving force control unit 15 acquires the vehicle state based on signals set in each section of the vehicle MV, information acquired through estimation from the signals, and the like. The braking/driving force control unit 15 outputs a braking/driving force instruction value calculated as a result of feedback control to various apparatuses mounted in the vehicle MV. The apparatuses include, for example, an inverter for adjusting a current supplied to the rotating electric machine and an electric brake apparatus. As the feedback control performed by the braking/driving force control unit 15, for example, various methods that are publicly known can be used. Therefore, detailed descriptions thereof are omitted.

The steering control unit 16 is a section that performs a process to cause the vehicle MV to travel based on the trajectory plan. The steering control unit 16 steers the vehicle MV so that the lateral position at each point of the vehicle MV traveling along the route matches the lateral position indicated in the trajectory plan.

The steering control unit 16 calculates a required steering amount based on the speed plan and the trajectory plan, and calculates a yaw rate instruction value corresponding to the steering amount. The steering control unit 16 outputs the yaw rate instruction value to an electric steering apparatus mounted in the vehicle MV, thereby actualizing traveling along the trajectory plan. As a specific method for calculating the steering amount and the yaw rate instruction value based on the speed plan and the trajectory plan, for example, various methods that are publicly known can be used. Therefore, detailed descriptions thereof are omitted. Here, a signal outputted from the steering control unit 16 toward the vehicle MV may be the yaw rate instruction value as according to the present embodiment. However, the signal may also be an instruction value that directly instructs the steering amount.

The overall braking/driving force control unit 15 and steering control unit 16 can be said to be a section that causes the vehicle MV to travel based on both the trajectory plan and the speed plan. The braking/driving force control unit 15 and the steering control unit 16 correspond to a “traveling control unit” according to the present embodiment.

Here, even in a case in which the control apparatus 10 instructs the target speed, the target trajectory, and the like to the occupant rather than automatically performing operations on behalf of the occupant, the traveling control unit still (in the end) causes the vehicle MV to travel based on both the trajectory plan and the speed plan.

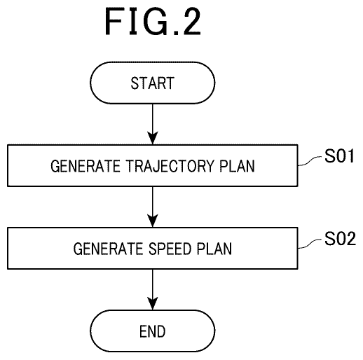

An overview of the processes performed by the control apparatus 10 will be described with reference to FIG. 2. A flowchart in FIG. 2 shows an order in which the first plan generation unit 13 generates the trajectory plan and the second plan generation unit 14 generates the speed plan. As shown in FIG. 2, the trajectory plan is generated at a first step S01, and the speed plan is generated in a following step S02.

In this manner, the control apparatus 10 according to the present embodiment is configured to first generate only the trajectory plan and then subsequently generate the speed plan on the premise of the existing trajectory plan, rather than simultaneously generating both the trajectory plan and the speed plan as a result of solving a single optimization problem. Benefits of generating the plans in an order such as this will be described hereafter.

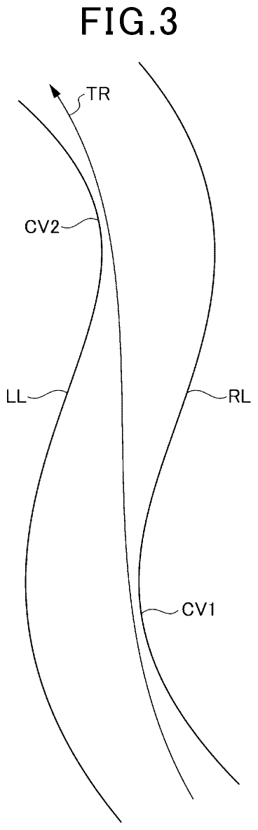

The method by which the first plan generation unit 13 generates the trajectory plan will be described. FIG. 3 shows an example of the generated trajectory plan. Line LL shown in FIG. 3 is a line indicating a boundary of a left edge of a track (specifically, a lane) on which the vehicle MV travels. Line RL is a line indicating a boundary of a right edge of the track on which the vehicle MV travels. In FIG. 3, the trajectory indicated in the calculated trajectory plan, that is, the trajectory on which the center position of the vehicle MV should pass, is shown by an arrow TR

In the example in FIG. 3, the track on which the vehicle MV travels is initially a curve section (curved road) CV1 that curves in a rightward direction and thereafter becomes a curve section (curved road) CV2 that curves in a leftward direction. As shown in FIG. 3, the vehicle MV traveling along the trajectory plan (arrow TR) enters the first curve section CV1 while changing the lateral position from a left side (that is, an outer side) of the center of the track to a right side. On the curve section CV1, the vehicle MV turns in the rightward direction along the track while traveling on the right side (that is, an inner side) of the center of the track. Subsequently, the vehicle MV exits the curve section CV1 and travels toward the next curve section CV2 while changing the lateral position from the right side of the center of the track to the left side (that is, the outer side) again.

Next, the vehicle MV enters the curve section CV2 while changing the lateral position from the right side (that is, the outer side) of the center of the track to the left side. On the curve section CV2, the vehicle MV turns in the leftward direction along the track while traveling on the left side (that is, the inner side) of the center of the track. Subsequently, the vehicle MV exits the curve section CV2 while changing the lateral position from the left side of the center of the track to the right side (that is, the outer side) again.

As shown by arrow TR in this example, the first plan generation unit 13 generates the trajectory plan so that the vehicle MV travels on each curve section on the route along a so-called “out-in-out” trajectory. The trajectory such as that shown by arrow TR can also be said to be a trajectory that enables the vehicle MV to travel without straying off the track and minimizes the curvature at each point.

By an arbitrary trajectory of the vehicle MV traveling on a route being divided into a plurality of segments every predetermined distance, for example, the curvature of the trajectory in each segment can be defined. With a sum of squares of the plurality of curvatures calculated in this manner as an evaluation function, if a trajectory in which the evaluation function is minimized is selected, a trajectory in which the curvature is minimized can be acquired as in the example shown by arrow TR. The first plan generation unit 13 according to the present embodiment generates the trajectory plan so that the vehicle MV travels on the curve sections along the out-in-out trajectory in a manner such as that above.

When the vehicle MV is caused to travel along such an out-in-out trajectory, the steering amount is relatively small. Therefore, the energy required for steering is suppressed. In addition, as a result of shortening of the traveling distance of the vehicle MV, reduction in a deceleration range accompanying decrease in lateral acceleration, and the like, the energy required for traveling is further suppressed. Based on simulations conducted by the inventors of the present invention, it has been confirmed that the energy consumption in the case in which the vehicle MV travels along the out-in-out trajectory is significantly less than that in a case in which the vehicle MV travels along a trajectory in the center of the lane.

In this manner, the first plan generation unit 13 generates the trajectory plan based only on the route on which the vehicle MV travels subsequent to the current position and topographic information (such as width and curvature) of the track included in the route. In other words, the trajectory plan is generated without any use of the speed at which the vehicle MV travels (that is, the speed plan) or vehicle specifications such as weight. Therefore, the computational load required to generate the trajectory plan is relatively small.

The first plan generation unit 13 according to the present embodiment generates the trajectory plan for an area from the current position of the vehicle MV to a position that is farther by a predetermined distance along the route. While the vehicle MV is traveling, the first plan generation unit 13 periodically generates and updates the trajectory plan such as that described above every time a predetermined period elapses. The generated trajectory plan is input from the first plan generation unit 13 to the second plan generation unit 14 and is used to generate the speed plan.

Here, in a case in which a destination or an overall route of the vehicle MV is determined in advance, the trajectory plan along the overall route may be generated at once before the vehicle MV starts traveling. Updates such as that described above may not be performed. For example, in a case in which the vehicle MV is a commercial vehicle or a fixed-route bus, such one-time generation of the trajectory plan is possible. In addition, even in cases in which the vehicle MV is a vehicle for general household use, one-time generation of the trajectory plan such as that described above is possible in cases in which, for example, target values and the route of the vehicle MV are inputted a day earlier.

The method by which the second plan generation unit 14 generates the speed plan will be described. As described above, the speed plan is generated as a plan that indicates the traveling speed of the vehicle MV at each point when the vehicle MV is caused to travel along the route set by the route setting unit 12.

Herebelow, a number of segments when the route to be traveled by the vehicle MV is segmented every fixed sampling distance is expressed by S. An index that is an integer value of any of 0 to S is expressed by k. In addition, if a target speed of the vehicle MV at a point farther from the current location by the sampling distance×k is denoted as v(k), the speed plan can be expressed as the set of v(k) for all values of k. Here, v(0) included in the speed plan refers to the current traveling speed of the vehicle MV. Therefore, this value is known.

The second plan generation unit 14 sets individual values of v(k) so that the value of the evaluation function indicated by expression (1), below, is minimized and thereby generates the speed plan.

$${\sum }_{k = 0}^{S - 1} [ {w}_{f} {F}^{2} ( k ) + {w}_{v} {\{ v ( k + 1 ) - {v}_{tgt} \}}^{2} ] \qquad ( 1 )$$

In expression (1), w_{f} and wᵥ are coefficients for weighting, F(k) denotes the braking/driving force at each point corresponding to the value of k, and v_{tgt} denotes the preset speed set in advance by the user by operating the operating unit 20.

When the vehicle MV is caused to travel so as avoid generating braking/driving force as much as possible through use of an own vehicle weight on the gradient, the sum of the squares of F(k) that is the braking/driving force (a first term of expression (1)) becomes smaller, and the energy required for traveling decreases. On the other hand, in this case, variation in the traveling speed of the vehicle MV increases, and the sum of the squares of the deviation between v(k+1) and V_{tgt} (a second term of expression (1)) increases. In this way, a trade-off relationship is present between using the own vehicle weight and maintaining the preset speed. It can be said that minimizing the evaluation function in expression (1) is to generate the speed plan so that the energy consumed by the braking/driving force is reduced while allowing some speed variation from the preset speed while fundamentally maintaining the preset speed.

Here, in solving the minimization problem in which the evaluation function in expression (1) is minimized, a constraint are set indicated in expression (2) below is set.

$$v ( k ) \leq {V}_{max} ( k ) \qquad ( 2 )$$

In expression (2), Vₘₐₓ(k) denotes a maximum value of the travel speed allowed at each point corresponding to the value of k. The value of each Vₘₐₓ(k) is calculated using a trajectory plan generated in advance. A method thereof will be described hereafter. The second plan generation unit 14 generates a speed plan by solving the minimization problem in which the evaluation function in expression (1) is minimized under the constraint in expression (2).

Expression (1) includes F(k) that denotes the braking/driving force. Therefore, solving the above-described minimization problem as is is difficult. Here, expression (1) is transformed as described below.

First, when force of an advancing direction component of the own vehicle weight applied to the vehicle MV at each point corresponding to the value of k is F_{grad}(k), F_{grad}(k) is expressed such as by expression (3) below.

$${F}_{grad} ( k ) = \{ \begin{matrix}g sin θ ( k ) : Downward gradient \\ - g sin θ ( k ) : Upward gradient\end{matrix} \qquad ( 3 )$$

In expression (3), g is gravitational acceleration, and θ(k) denotes the gradient of the track at each point corresponding to the value of k. When F_{grad}(k) is used, an equation of motion of the vehicle MV is expressed as in expression (4) below.

$$\dot{v} ( t ) = F ( t ) + {F}_{g r a d} ( {k}_{t} ) \qquad ( 4 )$$

In expression (4), F(t) expresses the braking/driving force as a function of time, and kₜ denotes a point index corresponding to time t among k described earlier. Here, as F(t) and F_{grad} (kₜ), the force applied to the vehicle MV normalized by the weight of the vehicle MV is used. Therefore, awareness of specific specifications of the vehicle MV is not necessary when using expression (4).

Here, the speed plan is generated on the premise that the traveling speed of the vehicle MV is adjusted to be near the preset speed. In this case, variations in air resistance acting on the vehicle MV during traveling can be considered to be generally constant. Therefore, effects of air resistance are ignored in expression (4).

When an initial speed of the vehicle MV is v₀, the traveling speed of the vehicle MV at a point after the elapse of time t is v(t), and a traveled distance of the vehicle MV up to this point is s(t), a relationship between v(t) and s(t) can be expressed as in expression (5) below based on expression (4) above.

$$v ( t ) = \sqrt{{v}_{0}^{2} + 2 \{ F ( t ) + {F}_{g r a d} ( {k}_{t} ) \} s ( t )} \qquad ( 5 )$$

If the distance traveled by the vehicle MV until the traveling speed of the vehicle MV changes from v(k) to v(k+1) is Δs, expression (6) below can be obtained from expression (5). Here, Δs is the “sampling distance” described earlier.

$$v ( k + 1 ) = \sqrt{{v}^{2} ( k ) + 2 \{ F ( k ) + {F}_{g r a d} ( k ) \} Δ s} \qquad ( 6 )$$

Expression (7) below can be obtained by the expression (6) being transformed.

$$F ( k ) = \frac{{v}^{2} ( k + 1 ) - {v}^{2} ( k )}{2 Δ s} - {F}_{g r a d} ( k ) \qquad ( 7 )$$

Expression (8) below can be obtained by substituting expression (7) in expression (1)

$${\sum }_{k = 0}^{S - 1} [ {w}_{f} {\{ \frac{{v}^{2} ( k + 1 ) - {v}^{2} ( k )}{2 Δ s} - {F}_{g r a d} ( k ) \}}^{2} + {w}_{v} {\{ v ( k + 1 ) - {v}_{tgt} \}}^{2} ] \qquad ( 8 )$$

Expression (8) is the evaluation function in expression (1) transformed to not include F(k). Expression (8) includes only v(k) that is a determination variable as an unknown variable. Therefore, a minimization problem such as that in which the evaluation function in expression (8) is minimized can be solved and v(k) can be acquired as the speed plan. It can be said that, with Δs as the “sampling distance” and the overall distance indicated by the range from 0 to S as a “horizon distance”, expression (8) is a speed plan problem formulated as a Model Predictive Control (MPC) problem described using both the sampling distance and the horizon distance.

Here, a second term in expression (8) is merely required to indicate a magnitude of the deviation between the traveling speed and the preset speed. Therefore, a term indicated by expression (9) below may be used instead of the second term in expression (8).

$${w}_{v} {\{ {v}^{2} ( k + 1 ) - {v}_{tgt}^{2} \}}^{2} \qquad ( 9 )$$

When the evaluation function in expression (8) is transformed as described above, the minimization problem can be attributed to a convex quadratic programming problem. Therefore, the minimization problem can be solved with relative ease using a general solver.

In solving the minimization problem, expression (10) below is used as the value of Vₘₐₓ(k) included in the constraint in expression (2).

$${V}_{max} ( k ) = \sqrt{\frac{{G}_{l m} \cdot g}{κ ( k )}} \qquad ( 10 )$$

In expression (10), g on the right side thereof is gravitational acceleration, Gₗₘ is an allowable upper limit value for lateral acceleration applied to the vehicle MV while traveling on a curved road, and is set as a predetermined numerical value (fixed value) in units of gravitational acceleration, and κ(k) denotes the curvature of the trajectory on which the vehicle MV is traveling at each point corresponding to the value of k. The value of κ(k) at each point can be easily calculated based on trajectory plan generated in advance.

In this way, v(k) can be acquired as the target speed at each point by the minimization problem in which expression (8) is minimized being solved while Vₘₐₓ(k) generated based on the trajectory plan is incorporated into the constraint. Here, v(k) at each point configuring the speed plan is rewritten below as v_{ref}(k).

Here, the speed plan generated as described above is a set of the target speed v_{ref}(k) at each point at every sampling distance. However, in using the speed plan for feedback control performed by the braking/driving force control unit 15, the speed plan is preferably expressed as a set of target speeds along a time series for every predetermined period. That is, the speed plan is preferably expressed in the form of v_{ref}(t) rather than v_{ref}(k). Therefore, the second plan generation unit 14 converts acquired obtained v_{ref}(t) by a method described below, and generates v_{ref}(t) as the final speed plan.

If the distance traveled by the vehicle MV until the traveling speed of the vehicle MV changes from v_{ref}(k) to v_{ref}(k+1) is Δs, the acceleration during the period in which the vehicle MV travels Δs can be approximately expressed as in expression (11) below.

$$\frac{{v}_{ref}^{2} ( k + 1 ) - {v}_{ref}^{2} ( k )}{2 Δ s} \qquad ( 11 )$$

If expression (11) is used, v_{ref}(t) at each time until the traveling speed of the vehicle MV changes from v_{ref}(k) to v_{ref}(k+1) can be calculated using expression (12) below.

$${v}_{ref} ( t + ( n + 1 ) Δ t ) = {v}_{ref} ( t + n Δ t ) + \frac{{v}_{ref}^{2} ( k + 1 ) - {v}_{ref}^{2} ( k )}{2 Δ s} \qquad ( 12 )$$

In expression (12), n is an integer starting from 0, and is a variable that is incremented by 1 for every speed feedback period, and Δt denotes the period in question.

Here, when the time in parentheses in v_{ref}(k+1) exceeds a range in expression (13) below in accompaniment with n being incremented, n may be reset to 0 simultaneously with k in expression (12) being stepped up by 1, and n may be incremented again.

$$t \leq t + ( n + 1 ) Δ t \leq t + \frac{2 Δ s}{{v}_{ref} ( k ) + {v}_{ref} ( k + 1 )} \qquad ( 13 )$$

Generation of the speed plan by a method such as that described above is performed periodically. Each time, the speed plan is updated so that the speed plan starts from the current position. The update of the speed plan may be performed every time the vehicle MV advances a predetermined distance, or every time a predetermined amount of time has elapsed. In either case, a frequency at which the second plan generation unit 14 updates the speed plan is preferably higher than a frequency at which the first plan generation unit 13 updates the trajectory plan. Here, the “frequency at which the first plan generation unit 13 updates the trajectory plan” also includes the case in which the trajectory plan is generated only once in the beginning, in the meaning of “frequency”.

As described above, in the control apparatus 10 according to the present embodiment, after the first plan generation unit 13 generates the trajectory plan, the second plan generation unit 14 generates the speed plan as the plan for causing the vehicle MV to travel based on the trajectory plan. In other words, rather than simultaneously generating both the trajectory plan and the speed plan by solving a complex optimization problem, the control apparatus 10 generates only the trajectory plan first independently of the speed plan. As a result, the computational load required to generate the trajectory plan can be reduced. In addition, the speed plan is generated on the premise of traveling based on the existing trajectory plan. Consequently, the computing load required to generate the speed plan can also be reduced.

For example, a process such as the foregoing is actualized by a program for the control apparatus 10 that is stored in the ROM of the control apparatus 10. The program causes the first plan generation unit 13 of the control apparatus 10 to perform a process to generate a trajectory plan (first plan generating process) (step S01 in FIG. 2), the second plan generation unit 14 of the control apparatus 10 perform a process to generate a speed plan (second plan generating process) (step S02 in FIG. 2), and the braking/driving force control unit 15, the steering control unit 16, and the like of the control apparatus 10 perform a process to cause a moving body to travel based on both the trajectory plan and the speed plan. The process to generate the speed plan (second plan generating process) is a process to generate the speed plan as a plan to cause the moving body to travel based on the trajectory plan, after the first plan generation unit 13 of the control apparatus 10 generates the trajectory plan.

Here, an effect of improving energy efficiency is small compared to the case in which both the trajectory plan and the speed plan are simultaneously generated by complex computation. However, because the required computational load can be significantly reduced, great advantages can be achieved, such as the overall control apparatus 10 being able to be configured as an onboard ECU.

The second plan generation unit 14 generates the speed plan on the premise of traveling based on the existing trajectory plan. Specifically, the second plan generation unit 14 calculates the maximum speed Vₘₐₓ(k) allowed at each point along the route using κ(k) acquired from the trajectory plan as in expression (10). By solving the optimization problem with V_{Max}(k) acquired in this manner as a constraint, the second plan generation unit 14 generates the speed plan in the form of v_{ref}(k) or v_{ref}(t) so that the traveling speed of the vehicle MV at each point along the route does not exceed the maximum speed V_{Max}(k).

In generating the speed plan, the second plan generation unit 14 generates the speed plan using the equation of motion in which the braking/driving force is normalized by the weight of the vehicle MV as in expression (4). Through use of a method such as this, the specifications of the vehicle MV are not required in generating the speed plan, in a manner similar to when the earlier trajectory plan is generated. Here, specifications such as weight are required in final adjustment of the braking/driving force. However, processes requiring such specifications are handled by the braking/driving force control unit 15 and the steering control unit 16 according to the present embodiment.

That is, according to the present embodiment, the braking/driving force control unit 15 and the like handle processes that require the specifications of the vehicle MV. Highly abstract processes that do not require the specifications of the vehicle are handled by the first plan generation unit 13 and the second plan generation unit 14. In this manner, matters to be formulated as an optimization problem are localized. In other words, sections that are difficult to artificially describe in control algorithms of the vehicle MV are formulated as an optimization problem. As a result of such localization, evaluation functions (expression (8) and constraint [expression (2)]) can be simplified. Reduction in computational load and shortening of solution time are actualized.

Here, in the control apparatus 10 according to the present embodiment, as a result of the generation of the trajectory plan and the generation of the speed plan being separated, the process required to generate each plan is simplified. Consequently, highly abstract formulation using the normalized equation of motion (expression (4)) is possible. That is, localization of the optimization problem as described above can also be considered to be achieved by the generation of the trajectory plan and the generation of the speed plan being separated.

The method for generating the trajectory plan and the speed plan described above reduces required computational resources, and improves size reduction of the control apparatus 10 and mountability in the vehicle MV. However, as described above, an aspect in which a portion or all of the control apparatus 10 is set in a position differing from the vehicle MV is also possible. Such an aspect is also included in the scope of the present disclosure. The moving body to be controlled by the control apparatus 10 may be the vehicle MV as according to the present embodiment and may also be a differing type of moving body from the vehicle MV.

The present embodiment is described above with reference to specific examples. However, the present invention is not limited to these specific examples. Design modifications to the above-described specific examples made as appropriate by a person skilled in the art are included in the scope of the present invention as long as features of the present invention are included. Elements included in the above-described specific examples, as well as arrangements, conditions, shapes, and the like thereof are not limited to those given as examples and can be modified as appropriate. Combinations of elements included in the above-described specific examples can be changed as appropriate as long as technical inconsistencies do not occur.

The control apparatus and the control method described in the present disclosure may be actualized by a dedicated computer that is provided such as to be configured by a processor and a memory, the processor being programmed to provide one or a plurality of functions that are realized by a computer program. The control apparatus and the control method described in the present disclosure may be actualized by a dedicated computer that is provided by a processor being configured by a single dedicated hardware logic circuit or more. The control apparatus and the control method described in the present disclosure may be actualized by a single dedicated computer or more. The dedicated computer may be configured by a combination of a processor that is programmed to provide one or a plurality of functions, a memory, and a processor that is configured by a single hardware logic circuit or more. The computer program may be stored in a non-transitory, tangible, computer-readable storage medium that can be read by a computer as instructions performed by the computer. The dedicated hardware logic circuit and the hardware logic circuit may be actualized by a digital circuit including a plurality of logic circuits or an analog circuit.

What is claimed is:

1. A control apparatus for a moving body, the control apparatus comprising:
a first plan generation unit that generates a trajectory plan that is a plan indicating a lateral position of the moving body at each point when the moving body is caused to travel along a predetermined route;
a second plan generation unit that generates a speed plan that is a plan indicating a traveling speed of the moving body at each point when the moving body is caused to travel along the route; and
a traveling control unit that causes the moving body to travel based on both the trajectory plan and the speed plan, wherein
the second plan generation unit generates the speed plan as a plan for causing the moving body to travel based on the trajectory plan after the first plan generation unit generates the trajectory plan.

2. The control apparatus according to claim 1, wherein:
the second plan generation unit
calculates a maximum speed allowed at each point along the route using the trajectory plan, and
generates the speed plan so that the traveling speed of the moving body at each point along the route does not exceed the maximum speed.

3. The control apparatus according to claim 2, wherein:
the traveling control unit causes the moving body to travel while performing feedback control so that a deviation between the traveling speed indicated in the speed plan and an actual traveling speed is reduced.

4. The control apparatus according to claim 3, wherein:
the first plan generation unit generates the trajectory plan so that the moving body travels on a curved road along an out-in-out trajectory.

5. The control apparatus according to claim 4, wherein:
a frequency by which the second plan generation unit updates the speed plan is higher than a frequency by which the first plan generation unit updates the trajectory plan.

6. The control apparatus according to claim 5, wherein:
the second plan generation unit generates the speed plan using an equation of motion in which a braking/driving force is normalized by a weight of the moving body.

7. The control apparatus according to claim 1, wherein:
the traveling control unit causes the moving body to travel while performing feedback control so that a deviation between the traveling speed indicated in the speed plan and an actual traveling speed is reduced.

8. The control apparatus according to claim 7, wherein:
the first plan generation unit generates the trajectory plan so that the moving body travels on a curved road along an out-in-out trajectory.

9. The control apparatus according to claim 8, wherein:
a frequency by which the second plan generation unit updates the speed plan is higher than a frequency by which the first plan generation unit updates the trajectory plan.

10. The control apparatus according to claim 9, wherein:
the second plan generation unit generates the speed plan using an equation of motion in which a braking/driving force is normalized by a weight of the moving body.

11. The control apparatus according to claim 1, wherein:
the first plan generation unit generates the trajectory plan so that the moving body travels on a curved road along an out-in-out trajectory.

12. The control apparatus according to claim 11, wherein:
a frequency by which the second plan generation unit updates the speed plan is higher than a frequency by which the first plan generation unit updates the trajectory plan.

13. The control apparatus according to claim 12, wherein:
the second plan generation unit generates the speed plan using an equation of motion in which a braking/driving force is normalized by a weight of the moving body.

14. The control apparatus according to claim 1, wherein:
a frequency by which the second plan generation unit updates the speed plan is higher than a frequency by which the first plan generation unit updates the trajectory plan.

15. The control apparatus according to claim 14, wherein:
the second plan generation unit generates the speed plan using an equation of motion in which a braking/driving force is normalized by a weight of the moving body.

16. The control apparatus according to claim 1, wherein:
the second plan generation unit generates the speed plan using an equation of motion in which a braking/driving force is normalized by a weight of the moving body.

17. A non-transitory computer-readable storage medium having stored thereon a program for a control apparatus of a moving body, the program causing the control apparatus to perform:
a first plan generating process of generating a trajectory plan that is a plan indicating a lateral position of the moving body at each point when the moving body is caused to travel along a predetermined route;
a second plan generating process of generating speed plan that is a plan indicating a traveling speed of the moving body at each point when the moving body is caused to travel along the route; and
a traveling control process of causing the moving body to travel based on both the trajectory plan and the speed plan, wherein
the second plan generating process comprises a process of generating the speed plan as a plan for causing the moving body to travel based on the trajectory plan after the trajectory plan is generated as the first plan generating process.

18. A control apparatus for a moving body, the control apparatus comprising:
a processor;
a non-transitory computer-readable storage medium;
a set of computer-executable instructions stored on the computer-readable storage medium that, when read and executed by the processor, cause the processor to implement:
generating a trajectory plan that is a plan indicating a lateral position of the moving body at each point when the moving body is caused to travel along a predetermined route;
generating a speed plan that is a plan indicating a traveling speed of the moving body at each point when the moving body is caused to travel along the route; and
causing the moving body to travel based on both the trajectory plan and the speed plan, wherein
generating the speed plan comprises generating the speed plan as a plan for causing the moving body to travel based on the trajectory plan after the the trajectory plan is generated.
